(19) United States
(12) Patent Application Publication
(10) Pub. No.: US 2015/0085227 A1
(43) Pub. Date: Mar. 26, 2015

(54) LIQUID CRYSTAL DISPLAY HAVING IMPROVED VIEWING ANGLE AND CONTRAST RATIO AND METHOD OF MANUFACTURING THE SAME

(71) Applicant: Samsung Display Co., Ltd., Yongin-City (KR)

(72) Inventors: Min Oh CHOI, Cheonan-si (KR); Boo-Kan KI, Yongin-si (KR); Kyeongha KIM, Hwaseong-si (KR); Seungbeom PARK, Hwaseong-si (KR); YongHwan SHIN, Yongin-si (KR)

(73) Assignee: Samsung Display Co., Ltd., Yongin-City (KR)

(21) Appl. No.: 14/254,171

(22) Filed: Apr. 16, 2014

(30) Foreign Application Priority Data
Sep. 23, 2013 (KR) 10-2013-0112698

(51) Int. Cl. G02F 1/13363; G02F 1/1337

(52) U.S. Cl. CPC G02F 1/13363; G02F 1/133711; G02F 1/133634; G02F 2001/133715
USPC 349/96; 29/458; 427/163.1; 427/508

(57) ABSTRACT

A display crystal display includes a liquid crystal display panel, a polarizing plate disposed on at least one surface of the liquid crystal display panel, and a retardation layer disposed between the liquid crystal display panel and the polarizing plate.

### CROSS-REFERENCE TO RELATED APPLICATION

This U.S. non-provisional patent application claims priority under 35 U.S.C. §119 to Korean Patent Application No. 10-2013-0112698, filed on Sep. 23, 2013, the contents of which are hereby incorporated by reference in their entirety.

### BACKGROUND

1. Field of Disclosure

The present disclosure relates generally to flat panel displays. More specifically, the present disclosure relates to a liquid crystal display having improved viewing angle and contrast ratio, as well as methods of manufacturing such a liquid crystal display.

2. Description of the Related Art

A liquid crystal display typically includes a liquid crystal display panel and a pair of polarizing plates respectively disposed at upper and lower sides of the liquid crystal display panel. In general, the liquid crystal display panel includes an array substrate on which a plurality of pixels is arranged in a matrix form, an opposite substrate facing the array substrate, and a liquid crystal layer which is interposed between the array substrate and the opposite substrate which includes liquid crystal molecules. The liquid crystal display panel can be classified into a liquid crystal display panel using a nematic liquid crystal phase and a liquid crystal display panel using a smectic liquid crystal phase.

As a representative liquid crystal display, a twisted nematic type liquid crystal display is widely used. The twisted nematic type liquid crystal display has superior light transmittance, but has narrow viewing angle.

The twisted nematic type liquid crystal display employs a discotic liquid crystal (DLC) compensation film to compensate for the viewing angle. The DLC compensation film is manufactured by coating a discotic liquid crystal on a tri-acetyl-cellulose film. However, the DLC compensation film is very expensive and a manufacturing process of the DLC compensation film is complex.

### SUMMARY

The present disclosure provides a liquid crystal display employing a retardation layer and a compensation film to improve contrast ratio and reduce manufacturing cost.

The present disclosure also provides a method of manufacturing such a liquid crystal display.

Embodiments of the inventive concept provide a liquid crystal display including a liquid crystal display panel, a first polarizing plate, and a second polarizing plate. The liquid crystal display panel includes a first substrate, a second substrate, a liquid crystal layer disposed between the first substrate and the second substrate, and a retardation layer disposed on an outer surface of the second substrate. The first polarizing plate is disposed on an outer surface of the first substrate so that the first substrate is positioned between the retardation layer and the first polarizing plate. A second polarizing plate is disposed on the retardation layer so that the retardation layer is positioned between the second substrate and the second polarizing plate. The retardation layer has refractive indices that satisfy n_{z}<nₓ=n_{y}. Nₓ, n_{y}, and n_{z} denote refractive indices in x-, y-, and z-axis directions when one surface of the second substrate is assumed as an x-y plane surface defining the x- and y-axis directions and substantially parallel to a surface of the liquid crystal display panel that is configured to display an image, and the z-axis direction is perpendicular to the x- and y-axis directions.

The retardation layer can include a discotic liquid crystal having the refractive indices that satisfy n_{z}<nₓ=n_{y}.

The first polarizing plate can include a compensation film disposed on the liquid crystal display panel, and a first polarizing film disposed on the compensation film and having a first polarization axis. The compensation film can be a biaxially-stretched film. The compensation film may have refractive indices that satisfy n_{z}<nₓ<n_{y}.

The second polarizing plate can include a second polarizing film disposed on the retardation layer and having a second polarization axis oriented substantially perpendicular to the first polarization axis.

A driving voltage in a black of the liquid crystal display panel may be about 7.4 volts or more.

A retardation value with respect to the z-axis of the compensation film may be about 30 nm to about 60 nm and a retardation value in the directions of the x-y axes may be about 70 nm to about 190 nm. A retardation value of the retardation layer in the directions of the x-y axes may be about 80 nm to about 190 nm. A retardation value in the x-y plane surface of the retardation layer may be equal to or smaller than about 10 nm.

The liquid crystal display may further include a first alignment layer disposed between the first substrate and the liquid crystal layer and having a rubbing direction oriented in a substantially same direction as the first polarization axis, and a second alignment layer disposed between the second substrate and the liquid crystal layer and having a rubbing direction oriented in a substantially same direction as the second polarizing axis.

The liquid crystal layer may include a twisted nematic liquid crystal. The liquid crystal layer may have an anisotropic refractive index of about 400 nm to about 480 nm. The liquid crystal layer may have a dielectric anisotropy of about 7 to about 13. The liquid crystal display can be formed so as not to include a DLC compensation film, i.e. the liquid crystal display may be formed without any DLC compensation film.

Embodiments of the inventive concept also provide a method of manufacturing a liquid crystal display, including forming a liquid crystal layer between a first substrate and a second substrate, forming a retardation layer on the second substrate, positioning a first polarizing plate on an outer surface of the first substrate so that the first substrate is positioned between the retardation layer and the first polarizing plate, and positioning a second polarizing plate on the retardation layer so that the retardation layer is positioned between the second substrate and the second polarizing plate. The retardation layer has refractive indices that satisfy n_{z}<nₓ=n_{y}. Nₓ, n_{y}, and n_{z} denote refractive indices in x-, y-, and z-axis directions when one surface of the second substrate is assumed as an x-y plane surface defining the x- and y-axis directions and substantially parallel to a surface of the liquid crystal display that is configured to display an image, and the z-axis direction is perpendicular to the x- and y-axis directions.

The forming of the retardation layer may further include mixing a discotic liquid crystal having the refractive indices that satisfy n_{z}<nₓ=n_{y} with a solvent, so as to form a discotic liquid crystal solution; and coating the solution on the second substrate to form an initial retardation layer, and curing the initial retardation layer to form the retardation layer.

According to the above, the viewing angle and the contrast ratio of the liquid crystal display may be improved. In addition, the liquid crystal display includes the retardation layer and the compensation film instead of a DLC compensation film (or multiple DLC compensation films), and thus the manufacturing cost of the liquid crystal display may be reduced.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a cross-sectional view showing a liquid crystal display according to an exemplary embodiment of the present disclosure;

FIG. 2 is a plan view showing the liquid crystal display shown in FIG. 1;

FIG. 3 is a cross-sectional view taken along a line I-I′ of FIG. 2;

FIG. 4 is an exploded perspective view showing a liquid crystal display according to an exemplary embodiment of the present disclosure;

FIG. 5 is a flowchart showing a method of manufacturing a liquid crystal display according to an exemplary embodiment of the present disclosure;

FIGS. 6A to 6C are graphs showing retardation values of a compensation film and retardation values of a retardation layer in accordance with the application of a black voltage when a polarization angle of a light passing through the liquid crystal display according to the present disclosure is about 80 degrees or more at upper, lower, left, and right directions and a contrast ratio is about 10 or more;

FIG. 7A is a graph showing a contrast ratio at left and right sides as a function of a viewing angle when a black voltage is applied to each pixel in a liquid crystal display according to the present disclosure and a conventional liquid crystal display; and

FIG. 7B is a graph showing a contrast ratio on upper and lower sides as a function of polarization angle when a black voltage is applied to each pixel in a liquid crystal display according to the present disclosure and a conventional liquid crystal display.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings. The drawings are not to scale. All numerical values are approximate and may vary.

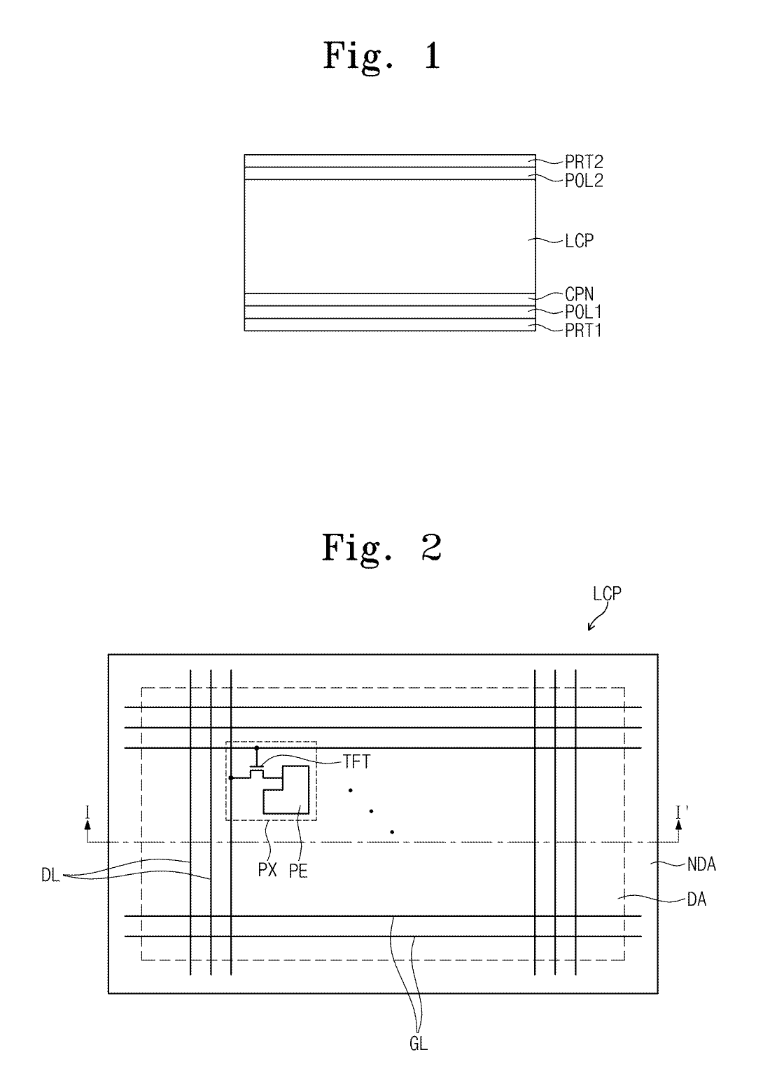

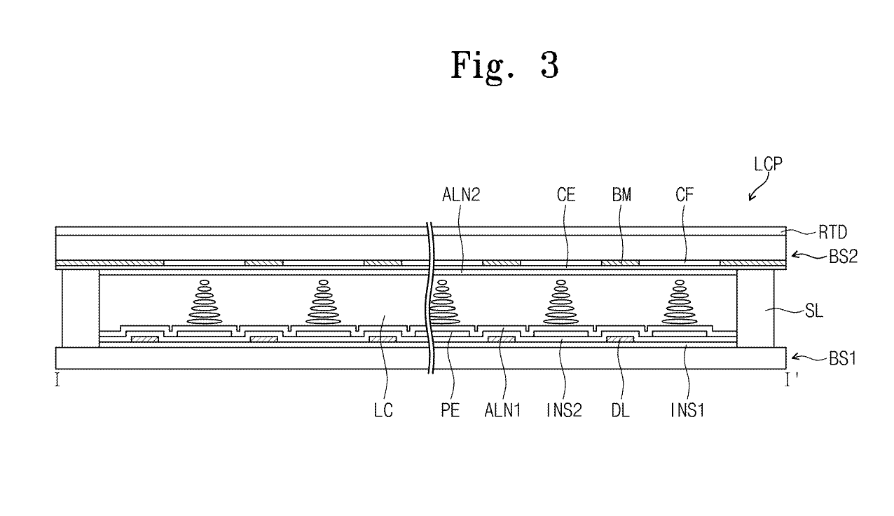

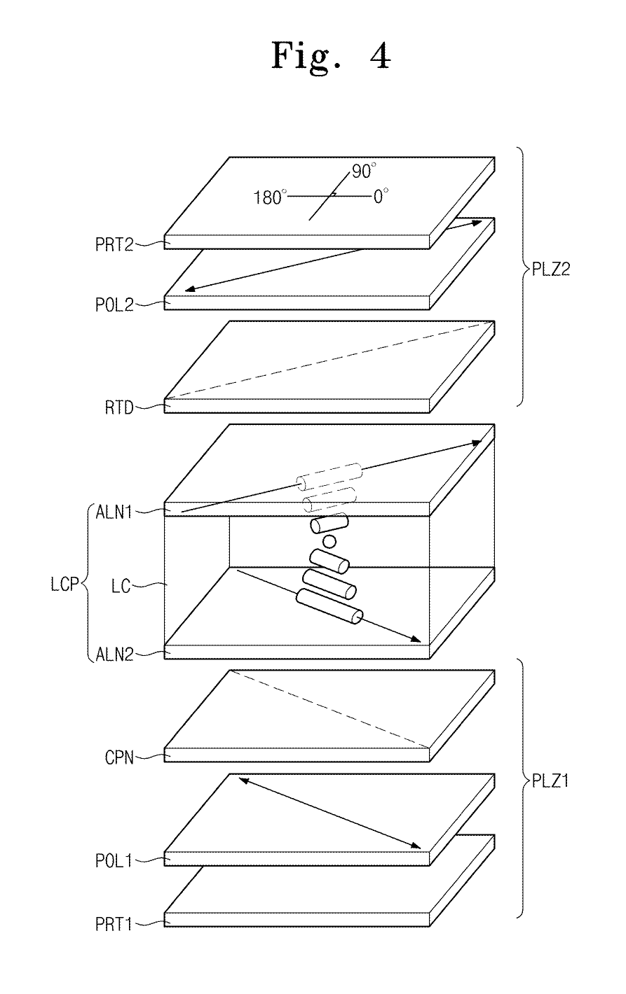

FIG. 1 is a cross-sectional view showing a liquid crystal display according to an exemplary embodiment of the present disclosure, FIG. 2 is a plan view showing the liquid crystal display shown in FIG. 1, and FIG. 3 is a cross-sectional view taken along a line I-I′ of FIG. 2.

Referring to FIGS. 1 to 3, a liquid crystal display includes a liquid crystal display panel LCP and first and second polarizing plates PLZ1 and PLZ2 respectively disposed at both side surfaces of the liquid crystal display panel LCP.

The liquid crystal display panel LCP has a rectangular shape with a pair of long sides and a pair of short sides.

The liquid crystal display panel LCP includes a first substrate BS1, a second substrate BS2 facing the first substrate BS1, a sealant SL that seals the gap between the first substrate BS1 and the second substrate BS2, a liquid crystal layer LC disposed between the first substrate BS1 and the second substrate BS2, and a retardation layer RTD disposed on an outer surface of the second substrate BS2.

The first substrate BS1 includes a display area DA in which a plurality of pixels PX is arranged to display an image, and a non-display area NDA disposed adjacent to at least one side of the display area DA, in which the image is not displayed.

The first substrate BS1 includes a wiring part that transmits signals, and also includes the pixels PX. The wiring part includes a plurality of gate lines GL disposed on the first substrate BS1 and a plurality of data lines DL crossing the gate lines GL. Each of the pixels PX includes a thin film transistor TFT connected to a corresponding gate line of the gate lines GL and a corresponding data line of the data lines DL, and also includes a pixel electrode PE connected to the thin film transistor TFT. The thin film transistor TFT applies a pixel voltage to the pixel electrode PE.

The thin film transistor TFT includes a gate electrode, an active layer, a source electrode, and a drain electrode. The gate electrode may be branched from the corresponding gate line of the gate lines GL. A first insulating layer INS1 is disposed on the first substrate BS1 to cover the gate electrode. The active layer is disposed on the first insulating layer INS1 and the source and drain electrodes are disposed on the active layer and spaced apart from each other to expose a portion of the active layer. In addition, the data lines DL are disposed on the first insulating layer INS1. The source electrode may be branched from the corresponding data line of the data lines DL.

A second insulating layer INS2 is disposed on the first insulating layer INS1 to cover the source electrode, the drain electrode, and the exposed active layer. The pixel electrode PE is disposed on the second insulating layer INS2 in each pixel PX and electrically connected to the drain electrode through a contact hole formed through the second insulating layer INS2.

The second substrate BS2 includes a common electrode CE disposed on one surface thereof to face the first substrate BS1. Color filters CF and a black matrix BM are disposed on the second substrate BS2, and the black matrix BM is provided with a plurality of openings formed therethrough to face the pixel electrode PE disposed on the first substrate BS1. Each opening has the same shape as that of its corresponding pixel electrode PE. The color filters CF are disposed in the openings, respectively. In this embodiment, each color filter represents one of a red color, a green color, or a blue color, although any colors are contemplated.

The liquid crystal layer LC is disposed between the first substrate BS1 and the second substrate BS2. The liquid crystal layer LC includes a twisted nematic liquid crystal. The twisted nematic liquid crystal has a dielectric anisotropy of about 7 to about 13 and a retardation value of about 400 nm to about 480 nm. The dielectric anisotropy and the retardation value of the twisted nematic liquid crystal are varied depending on characteristics of a polarizing film and a compensation film, which will be described later.

The sealant SL is disposed between the first substrate BS1 and the second substrate BS2 to correspond to the non-display area NDA. The sealant SL is provided along an edge of the first substrate BS and/or the second substrate BS2 to seal the liquid crystal layer LC.

A first alignment layer ALN1 is disposed between the liquid crystal layer LC and the first substrate BS1, and a second alignment layer ALN2 is disposed between the liquid crystal layer LC and the second substrate BS2, to align the liquid crystal layer LC. The first and second alignment layers ALN1 and ALN2 may include polyimide, polyamide, polyacrylate, or polyvinylalcohol.

The retardation layer RTD is disposed on the outer surface of the second substrate BS2, which is opposite to a surface of substrate BS2 that makes contact with the liquid crystal layer LC. That is, the retardation layer RTD is disposed on the opposite surface to the surface on which the common electrode CE is disposed. The retardation layer RTD may directly make contact with the outer surface of the second substrate BS2. The retardation layer RTD retards the light passing therethrough.

The retardation layer RTD may be a negative C-plate. In the case that one surface of the second substrate BS2 is referred to as an x-y plane surface, an upper direction vertical to the x-y plane surface is referred to as a z-axis, and refractive indices in x-, y-, and z-axis directions are referred to as nₓ, n_{y}, and n_{z}, respectively, the retardation layer RTD satisfies the following Expression 1.

n_{z}<nₓ=n_{y} Expression 1

In the retardation layer RTD, the retardation value Rth in the z-axis direction of the light passing through the retardation layer RTD is in a range of about 70 nm to about 200 nm. In addition, the retardation value Ro of the light passing through the retardation layer RTD in the x-y plane surface is about 10 nm or less, e.g., a value approximate to 0.

The retardation value Rth of the light in the z-axis direction and the retardation value Ro of the light with respect to the x-y plane surface satisfy the following Expressions 2 and 3, respectively. In the following Expressions 2 and 3, “d” denotes a distance, e.g., a cell gap, between the first substrate BS1 and the second substrate BS2.

Ro=(nₓ−n_{y})×d Expression 2

Rth={(nₓ+n_{y})/2−n_{z}}×d Expression 3

The retardation layer RTD may include a discotic liquid crystal such that nₓ, n_{y}, and n_{z} satisfy Expressions 2 and 3. The discotic liquid crystal may be included in a polymer matrix, such as polyimide, polyamideimide, polyamide, polyetherimide, polyetheretherketone, polyketonesulfide, polyethersulfone, cycloolefinpolymer, polysulfone, polyphenylenesulfide, polyphenyleneoxide, polyethyleneterephthalate, polybutyleneterephthalate, polyethylenenaphthalate, polyacetal, polycarbonate, polyacrylate, acrylic resin, polyvinylalcohol, polypropylene, cellulose, triacetyl-cellulose, epoxy resin, phenol resin, etc.

The first polarizing plate PLZ1 and the second polarizing plate PLZ2 are respectively disposed on surfaces of the liquid crystal display panel LCP which are opposite to each other. The first polarizing plate PLZ1 is disposed on an outer surface of the first substrate BS1, which is opposite to the surface on which the first alignment layer ALN1 is disposed. The second polarizing plate PLZ2 is disposed on the retardation layer RTD.

The first polarizing plate PLZ1 includes a compensation film CPN disposed on the outer surface of the first substrate BS1, a first polarizing film POL1 disposed on the compensation film CPN, and a first protective film PRT1 disposed on the first polarizing film POL1. The compensation film CPN may be attached to the outer surface of the first substrate BS1 by an adhesive (not shown) provided between the compensation film CPN and the outer surface of the first substrate BS1.

The first polarizing film POL1 is formed of a polymer resin elongated in a specific direction. The polymer resin may be a polyvinylalcohol resin. The polyvinylalcohol resin is obtained by saponifying polyvinyl acetate resin, e.g., a homopolymer of vinyl acetate or a copolymer of vinyl acetate with at least one other monomer. Unsaturated carboxylic acid, olefin, vinyl ether, and/or unsaturated sulfonic acid may be used for the monomer.

The compensation film CPN includes a thermoplastic resin, e.g., polysulfone, polymethyl methacrylate, polystyrene, polycarbonate, polyvinyl chloride, norbornene, etc. The thermoplastic resin may be used by itself or combined with other compounds such as those listed.

The second polarizing plate PLZ2 includes a second polarizing film POL2 on the retardation layer RTD and a second protective film PRT2 disposed on the second polarizing film POL2. The second polarizing film POL2 is attached to the retardation layer RTD by an adhesive (not shown) provided between the second polarizing film POL2 and the retardation layer RTD.

When the thin film transistor TFT is turned on in response to a driving signal provided through the gate line GL, an image signal provided through the data line DL is applied to the pixel electrode PE through the turned-on thin film transistor TFT. Accordingly, an electric field is generated between the pixel electrode PE and the common electrode CE to which the common voltage is applied. Therefore, liquid crystal molecules are realigned in accordance with the electric field, and thus the image is displayed according to an amount of the light passing through the liquid crystal layer LC.

The liquid crystal display is operated in a normally white mode. That is, each pixel of the liquid crystal display displays a white color when the electric field is not applied to the liquid crystal layer LC, and displays a black color when the electric field is applied to the liquid crystal layer LC. Here, the driving voltage for display of the black color is about 7.4 volts or more, but it should not be limited thereto or thereby. That is, the driving voltage of the liquid crystal display panel may be changed depending on the driving mode of the liquid crystal molecules or the dielectric anisotropy of the liquid crystal molecules.

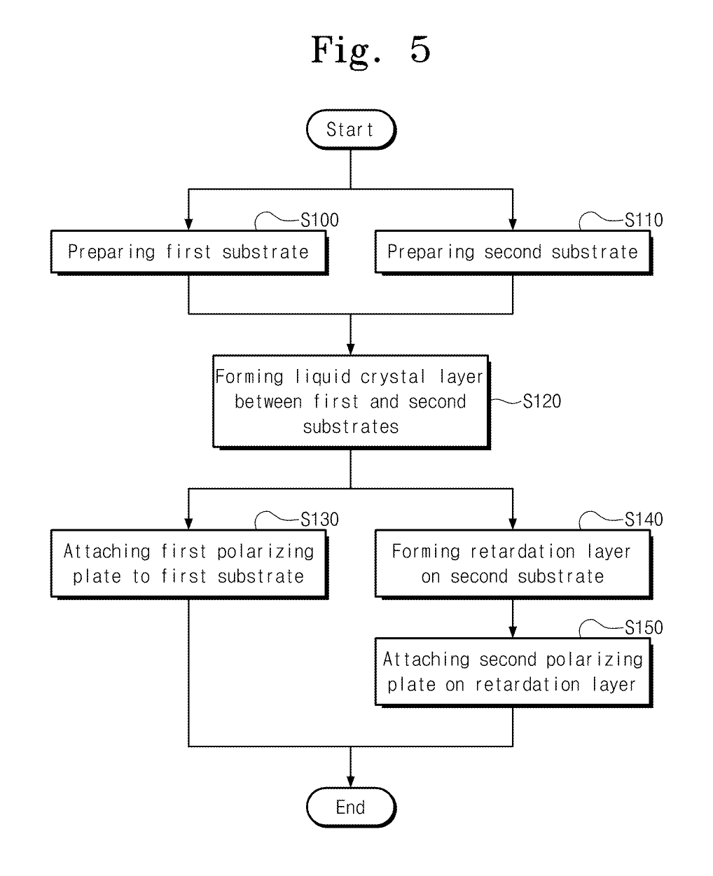

FIG. 4 is an exploded perspective view showing a liquid crystal display according to an exemplary embodiment of the present disclosure. For the convenience of explanation, the first and second substrates of the liquid crystal display panel have been omitted in FIG. 4.

Referring to FIG. 4, the first and second polarizing plates PLZ1 and PLZ2 are provided such that the liquid crystal display panel LCP is disposed between the first and second polarizing plates PLZ1 and PLZ2.

In the liquid crystal display panel LCP, the first alignment layer ALN1 may be rubbed in a direction of about 135°±10° when measured relative to the horizontal axis shown in FIG. 4 (e.g., the “180°−0°” line shown near the top of FIG. 4, parallel to the major axis of each layer shown). The second alignment layer ALN2 may be rubbed in a direction of about 45°±10°. When the liquid crystal display panel LCP has a rectangular shape with a pair of long sides and a pair of short sides, the angle of the polarizing axis is defined with reference to one of the directions in which the long sides extend. For instance, one of the directions in which the short sides extend is about 90 degrees and the other one of the directions in which the short sides extend is about 270 degrees.

The retardation layer RTD acts as the negative C-plate. The retardation layer RTD compensates for the viewing angle of the light passing through the second polarizing plate PLZ2. The retardation layer RTD includes discotic liquid crystal, and in this case an optical property of the retardation layer RTD is determined depending on an optical property of the discotic liquid crystal. In the present exemplary embodiment, the refractive indices of the discotic liquid crystal may satisfy Expression 1, i.e., n_{z}<nₓ=n_{y}.

The first polarizing plate PLZ1 includes the compensation film CPN, the first polarizing film POL1, and the first protective film PRT1, which are sequentially stacked on the liquid crystal display panel LCP.

The first polarizing film POL1 absorbs light that vibrates in a specific direction to polarize the light passing through the first polarizing film POL1 in a predetermined direction.

In the present exemplary embodiment, when the first polarizing film POL1 absorbs the light that vibrates in a first direction and the first direction is referred to as a first polarizing axis, the first polarizing axis may be substantially parallel to the rubbing direction of the first alignment layer. For instance, the first polarizing axis may be oriented in the direction of about 135°±10°. The first protective film POL1 is disposed on the first polarizing film POL1 to protect the first polarizing film POL1 from external impacts, e.g., scratches.

The compensation film CPN compensates for the viewing angle of the light passing through the first polarizing plate PLZ1. The compensation film CPN may be a biaxially-stretched film. In the case that the outer surface of the first substrate is referred to as an x-y plane surface, an axis vertical to the x-y plane surface is referred to as a z-axis, and refractive indices in x-, y-, and z-axis directions are referred to as nₓ, n_{y}, and n_{z}, respectively, the compensation layer CPN satisfies the following Expression 4.

n_{z}<nₓ<n_{y} Expression 4

In the compensation layer CPN, the retardation value Rth in the z-axis direction of the light passing through the compensation layer CPN is in a range of about 60 nm to about 200 nm. In addition, the retardation value Ro of the light passing through the compensation layer CPN with respect to the x-y plane surface is in a range of about 30 nm to about 60 nm.

The second polarizing plate PLZ2 includes the second polarizing film POL2 and the second protective film PRT2, which are sequentially stacked on the retardation layer RTD.

The second polarizing film POL2 and the second protective film PRT2 can be made of substantially the same materials as the first polarizing film POL1 and the first protective film PRT1, respectively.

The second polarizing film POL2 has a second polarizing axis crossing (e.g., substantially perpendicular to) the first polarizing axis. In the present exemplary embodiment, the second polarizing axis may be oriented in a direction of about 45°±10°.

The second protective film PRT2 is disposed on the second polarizing film POL2 to protect the second polarizing film POL2 from external impacts, e.g., scratches.

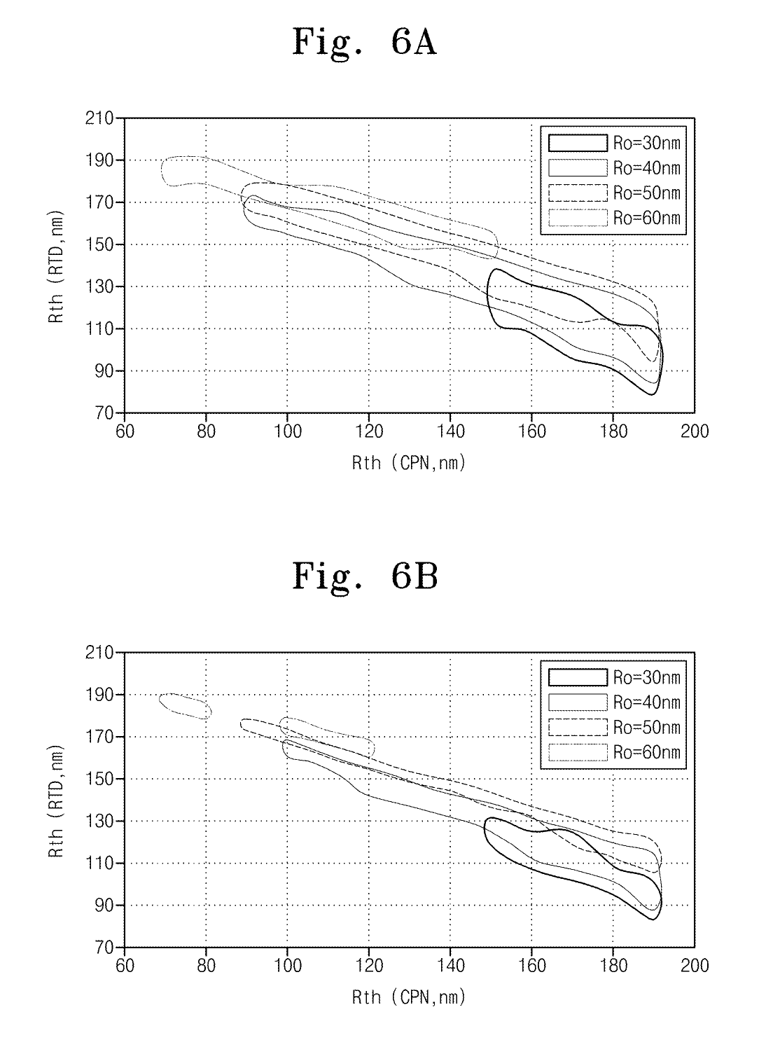

FIG. 5 is a flowchart showing a method of manufacturing a liquid crystal display according to an exemplary embodiment of the present disclosure.

Referring to FIG. 5, the liquid crystal display panel is formed to include the liquid crystal display.

The liquid crystal display panel is manufactured by forming the first and second substrates (S100 and S110), forming the liquid crystal layer between the first and second substrates (S120), and forming the retardation layer on the second substrate (S140).

Before the liquid crystal layer is formed between the first and second substrates, the pixel electrode is formed on the first substrate and the common electrode is formed on the second substrate. That is, the gate line, the data line, the thin film transistor, the pixel electrode, the first and second insulating layers, and the first alignment layer are formed on the first substrate. In addition, the color filter, the black matrix, the common electrode, and the second alignment layer are formed on the second substrate. Each component may be formed through various methods, as is known to those of ordinary skill in the art.

The retardation layer is formed by coating a discotic liquid crystal solution or mixture on the second substrate to form an initial retardation layer, and then curing the initial retardation layer.

The discotic liquid crystal mixture is formed by mixing the discotic liquid crystal with a solvent. The discotic liquid crystal mixture may include various compounds besides the discotic liquid crystal and the solvent, which do not exert influences on the optical property of the discotic liquid crystal. For instance, the compounds may be curable polymer materials in which a polymerization reaction occurs due to heat or light. In the present exemplary embodiment, the polymerizable polymer material may include a vinyl group, an oxy-vinyl group, an acrylic group, or a methacryl group. The solvent should not be limited to a specific solvent. The solvent may be hydrocarbons, such as cyclohexane, cyclopentane, benzene, toluene, xylene, butylbenzene, etc., ketones, such as acetone, methylethylketone, methylisobutylketone, cyclohexanone, etc., esters, such as acetic acid ethyl, ethyleneglycolmonomethyletheracetate, propylene, glycolmonomethyletheracetate, gamma-butyrolactone, etc., amides, such as 2-pyrrolidone, N-methyl-2-pyrrolidone, dimethylformamide, dimethylaceteamide, etc., halogens, such as chloroform, dichloromethane, carbon tetrachloride, dichloroethane, tetrachloroethane, tetrachloroethylene, chlorobenzene, etc., alcohols, such as t-butylalcohol, diacetonealcohol, glycerin, monoacetin, ethyleneglycol, triethyleneglycol, hexyleneglycol, ethyleneglycolmonomethylether, etc., phenols, such as phenol, parachlorophenol, etc., or ethers, such as methoxybenzene, 1,2-dimethoxybenzene, diethylglycol dimethylether, ethyleneglycol dimethylether, ethyleneglycol diethylether, propyleneglycol dimethylether, propyleneglycol diethylether, diethyleneglycol dimethylether, diethyleneglycol diethylether, dipropyleneglycol dimethylether, dipropyleneglycol diethylether, etc. In addition, those solvents may be used alone or in a combination of two or more kinds, and the usage amount of the solvents should not be limited to any specific amount.

The compounds may further include a light reaction initiator, a surfactant, and a chiral dopant.

The initial retardation layer may be formed on the second substrate through various methods, e.g., a spin coating method, a roll coating method, a printing method, a dip-drawing method, a curtain coating method, a dye coating method, a dip coating method, etc.

The initial retardation layer may be formed by performing a pre-baking process to remove at least a portion of the solvent, and an exposing process to polymerize the polymerizable compounds. In the exposing process, ultraviolet light is used as the light, but embodiments of the invention are not limited to using ultraviolet light. Any suitable light or radiation may be used.

Then, the first polarizing plate PLZ1 is attached to the outer surface of the first substrate (S130) and the second polarizing plate is attached to the outer surface of the second substrate (S150).

The first polarizing plate PLZ1 is attached to the first substrate by preparing a release film, the adhesive layer, the compensation film CPN, the first polarizing film POL1, and the protective film PRT1, which are sequentially stacked one on another; removing the release film; and allowing the adhesive layer to be sandwiched between the first substrate and the compensation film CPN.

The second polarizing plate PLZ2 is attached to the second substrate by preparing a release film, the adhesive layer, the second polarizing film POL2, and the protective film PRT2, which are sequentially stacked one on another; removing the release film; and allowing the adhesive layer to be sandwiched between the retardation layer RTD and the second polarizing film POL2.

The first and second polarizing plates POL1, POL2 may be manufactured by elongating the polymer resin.

The compensation film having the above-mentioned structure may be formed by a melting extrusion method. That is, the compensation film is manufactured by heating a thermo-plastic resin to allow the thermo-plastic resin to reach a temperature approximately equal to its glass transition temperature, passing the thermo-plastic resin between rollers rotated at different speeds to firstly elongate the thermo-plastic resin, and passing the thermo-plastic resin between rollers whose axes are oriented in a different direction from that of the rollers used for the first elongation step, to secondly elongate the thermo-plastic resin again. The thermo-plastic resin has an isotropic property at the temperature approximate to the glass transition temperature, but has an anisotropic property after being elongated. Here, the first elongation is performed on the thermo-plastic resin in a direction substantially parallel to the first polarizing axis, and the second elongation is performed on the thermo-plastic resin in a direction crossing (e.g., perpendicular to) the polarizing axis. The angles of the first and second elongations are determined depending on the kind of the polymer resin, the strength of the elongation, and the optical axis of the compensation film. In the present exemplary embodiment, the first elongation is performed in a direction of about 315°±10° and the second elongation is performed in a direction of about 45°±10°.

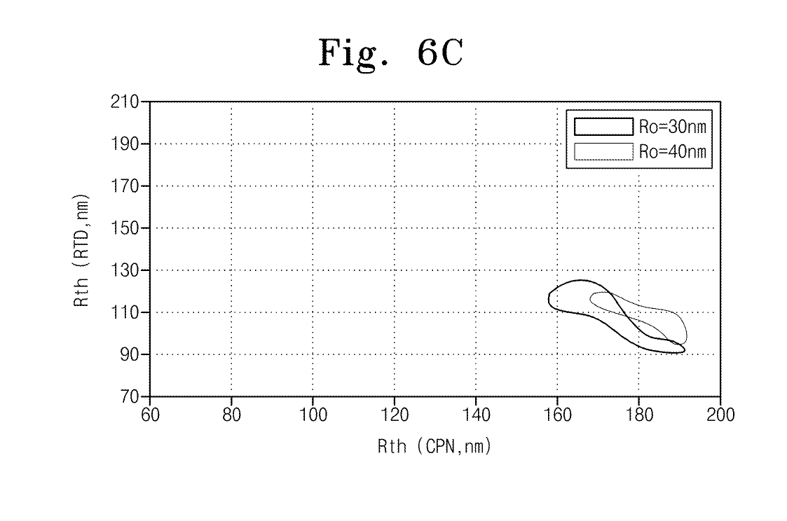

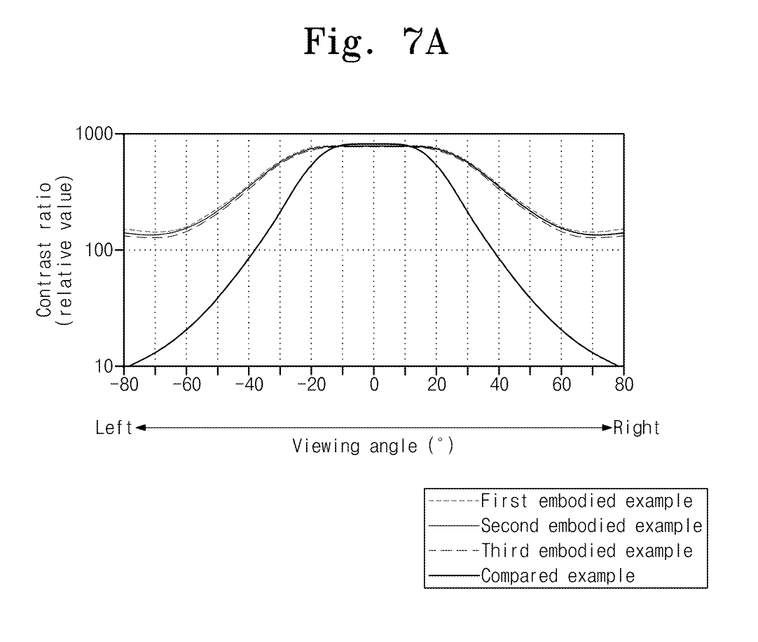

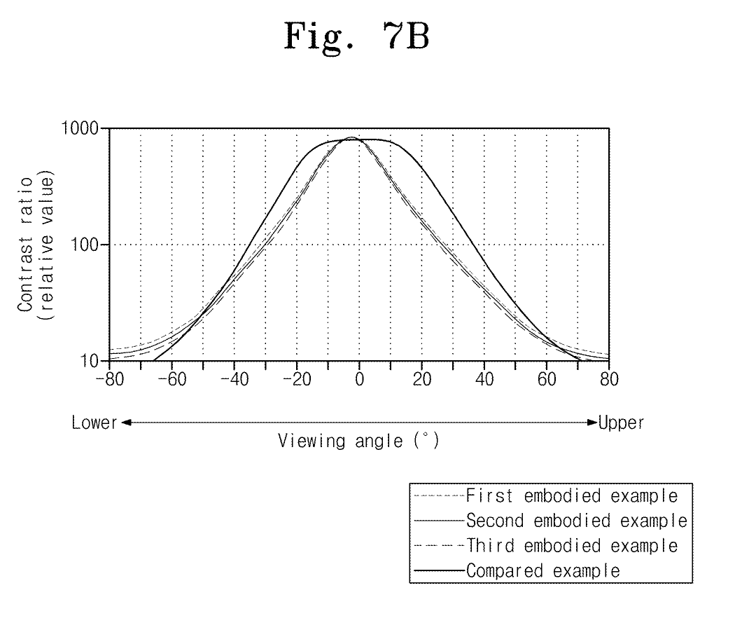

The liquid crystal display having the above-mentioned structure may display images with improved viewing angle and contrast ratio. This will be described in further detail with reference to FIGS. 6A to 6C and 7A and 7B.

FIGS. 6A to 6C are graphs showing retardation values of a compensation film and retardation values of a retardation layer in accordance with the application of a black voltage when a polarization angle of light passing through the liquid crystal display according to the present disclosure is about 80 degrees or more at upper, lower, left, and right directions, and a contrast ratio is about 10 or more. In the liquid crystal display according to the present disclosure, FIGS. 6A, 6B, and 6C show the retardation values when the voltage applied to the liquid crystal layer is about 7.8 volts, about 7.6 volts, and about 7.4 volts respectively, while the pixels represent the black color. In the graphs shown in FIGS. 6A, 6B, and 6C, the “Ro” value corresponds to the “Ro” value of the compensation film.

The upper, lower, left, and right directions are determined with reference to a user who watches the image displayed on the liquid crystal display (i.e., from the point of view of someone facing the image-producing surface of the display). In the present exemplary embodiment, since the viewing angle is narrow and the contrast ratio is small when the polarization angle is about 80 degrees or less and the contrast ratio is about 10 or less, the image may be not perceived by the user when the user watches the liquid crystal display from a side portion.

Referring to FIG. 6A, when the retardation value of the compensation film in the z-axis direction is about 30 nm to about 60 nm, the retardation value of the compensation film in the x-y axes is about 70 nm to about 190 nm and the retardation value of the retardation layer in the x-y axes is about 80 nm to about 190 nm.

In detail, when the retardation value of the compensation film in the z-axis direction is about 30 nm, the retardation value of the compensation film in the x-y axes is about 150 nm to about 190 nm and the retardation value of the retardation layer in the x-y axes is about 80 nm to about 140 nm. When the retardation value of the compensation film in the z-axis direction is about 40 nm, the retardation value of the compensation film in the x-y axes is about 90 nm to about 190 nm and the retardation value of the retardation layer in the x-y axes is about 85 nm to about 175 nm. When the retardation value of the compensation film in the z-axis direction is about 50 nm, the retardation value of the compensation film in the x-y axes is about 90 nm to about 190 nm and the retardation value of the retardation layer in the x-y axes is about 95 nm to about 180 nm. When the retardation value of the compensation film in the z-axis direction is about 60 nm, the retardation value of the compensation film in the x-y axes is about 70 nm to about 150 nm and the retardation value of the retardation layer in the x-y axes is about 145 nm to about 190 nm.

Referring to FIG. 6B, when the retardation value of the compensation film in the z-axis direction is about 30 nm to about 60 nm, the retardation value of the compensation film in the x-y axes is about 70 nm to about 190 nm and the retardation value of the retardation layer in the x-y axes is about 80 nm to about 190 nm.

In detail, when the retardation value of the compensation film in the z-axis direction is about 30 nm, the retardation value of the compensation film in the x-y axes is about 150 nm to about 190 nm and the retardation value of the retardation layer in the x-y axes is about 80 nm to about 130 nm. When the retardation value of the compensation film in the z-axis direction is about 40 nm, the retardation value of the compensation film in the x-y axes is about 100 nm to about 190 nm and the retardation value of the retardation layer in the x-y axes is about 90 nm to about 170 nm. When the retardation value of the compensation film in the z-axis direction is about 50 nm, the retardation value of the compensation film in the x-y axes is about 90 nm to about 190 nm and the retardation value of the retardation layer in the x-y axes is about 105 nm to about 180 nm. When the retardation value of the compensation film in the z-axis direction is about 60 nm, the retardation value of the compensation film in the x-y axes is about 70 nm to about 120 nm and the retardation value of the retardation layer in the x-y axes is about 160 nm to about 190 nm.

Referring to FIG. 6C, when the retardation value of the compensation film in the z-axis direction is about 30 nm to about 40 nm, the retardation value of the compensation film in the x-y axes is about 160 nm to about 190 nm and the retardation value of the retardation layer in the x-y axes is about 90 nm to about 125 nm.

In detail, when the retardation value of the compensation film in the z-axis direction is about 30 nm, the retardation value of the compensation film in the x-y axes is about 160 nm to about 190 nm and the retardation value of the retardation layer in the x-y axes is about 90 nm to about 125 nm. When the retardation value of the compensation film in the z-axis direction is about 40 nm, the retardation value of the compensation film in the x-y axes is about 170 nm to about 190 nm and the retardation value of the retardation layer in the x-y axes is about 95 nm to about 120 nm.

As shown in FIGS. 6A to 6C, the retardation values of the compensation film and the retardation layer in the x-y axes or the z-axis may be varied in accordance with the voltage applied to each pixel. In addition, when the retardation value in the z-axis direction of the compensation film is from about 30 nm to about 60 nm, the retardation value in the x-y axes of the compensation film is preferably in the range of about 70 nm to about 190 nm and the retardation value in the x-y axes of the retardation layer is preferably in the range of about 80 nm to about 190 nm to satisfy the polarization angle of about 80 degrees or more and the contrast ratio of about 10 or more.

FIG. 7A is a graph showing a contrast ratio on left and right sides as a function of viewing angle when a black voltage is applied to each pixel in both a liquid crystal display according to the present disclosure and a conventional liquid crystal display, and FIG. 7B is a graph showing a contrast ratio on upper and lower sides as a function of polarization angle when a black voltage is applied to each pixel in both a liquid crystal display according to the present disclosure and a conventional liquid crystal display.

In FIGS. 7A and 7B, a compared example shows a contrast ratio of a conventional liquid crystal display in which a conventional DLC compensation film is attached to both surfaces of the liquid crystal display panel, and first, second, and third embodied examples show the contrast ratio when the black pixel voltages in a liquid crystal display according to the present exemplary embodiment are about 7.8 volts, about 7.6 volts, and about 7.4 volts, respectively.

Referring to FIG. 7A, the contrast ratio in left and right directions as a function of viewing angle has been improved in the first to third embodied examples, as compared with the compared example. In particular, as the viewing angle becomes large, the contrast ratio in the left and right directions has been significantly improved regardless of the variation in the black pixel voltage.

Referring to FIG. 7B, the contrast ratio in upper and lower directions as a function of viewing angle has been slightly reduced in the first to third embodied examples, as compared with the compared example. Accordingly, no significant difference in contrast ratio exists between the compared example and the embodied examples. Only a slight difference is shown.

As described above, the contrast ratio in the upper and lower directions of the liquid crystal display is similar to that of the conventional liquid crystal display, but the contrast ratio in the left and right directions of the liquid crystal display is significantly better than the conventional liquid crystal display. In addition, the conventional liquid crystal display includes two DLC compensation films, but the liquid crystal display of embodiments of the invention does not need to include the DLC compensation film. That is, the displays of embodiments of the invention can be fabricated without DLC compensation films. Thus, the manufacturing cost of the liquid crystal display is reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Accordingly, various features of the embodiments may be mixed and matched in any manner to form other embodiments contemplated by the invention.

What is claimed is:

1. A liquid crystal display comprising:
a liquid crystal display panel that includes a first substrate, a second substrate, a liquid crystal layer disposed between the first substrate and the second substrate, and a retardation layer disposed on an outer surface of the second substrate;
a first polarizing plate disposed on an outer surface of the first substrate so that the first substrate is positioned between the retardation layer and the first polarizing plate; and
a second polarizing plate disposed on the retardation layer so that the retardation layer is positioned between the second substrate and the second polarizing plate,
wherein the retardation layer has refractive indices that satisfy n_{z}<nₓ=n_{y}, where nₓ, n_{y}, and n_{z} denote refractive indices in x-, y-, and z-axis directions when one surface of the second substrate is an x-y plane surface defining the x- and y-axis directions and substantially parallel to a surface of the liquid crystal display panel that is configured to display an image, and the z-axis direction is perpendicular to the x- and y-axis directions.

2. The liquid crystal display of claim 1, wherein the retardation layer comprises a discotic liquid crystal having the refractive indices that satisfy n_{z}<nₓ=n_{y}.

3. The liquid crystal display of claim 2, wherein the first polarizing plate comprises:
a compensation film disposed on the liquid crystal display panel; and
a first polarizing film disposed on the compensation film and having a first polarization axis.

4. The liquid crystal display of claim 3, wherein the compensation film is a biaxially-stretched film.

5. The liquid crystal display of claim 4, wherein the compensation film has refractive indices that satisfy n_{z}<nₓ<n_{y}.

6. The liquid crystal display of claim 3, wherein the second polarizing plate comprises a second polarizing film disposed on the retardation layer and having a second polarization axis oriented substantially perpendicular to the first polarization axis.

7. The liquid crystal display of claim 3, wherein a driving voltage is about 7.4 volts or more when the liquid crystal display panel displays a black color.

8. The liquid crystal display of claim 7, wherein a retardation value with respect to the x-y plane surface of the compensation film is about 30 nm to about 60 nm and a retardation value in the z-axis direction is about 60 nm to about 200 nm.

9. The liquid crystal display of claim 8, wherein a retardation value in the z-axis direction of the retardation layer is about 70 nm to about 200 nm.

10. The liquid crystal display of claim 9, wherein a retardation value of the retardation layer in the x-y axes is equal to or smaller than about 10 nm.

11. The liquid crystal display of claim 7, further comprising:
a first alignment layer disposed between the first substrate and the liquid crystal layer and having a rubbing direction oriented in a substantially same direction as the first polarization axis; and
a second alignment layer disposed between the second substrate and the liquid crystal layer and having a rubbing direction oriented in a substantially same direction as the second polarizing axis.

12. The liquid crystal display of claim 1, wherein the liquid crystal layer comprises a twisted nematic liquid crystal.

13. The liquid crystal display of claim 1, wherein the liquid crystal layer has an anisotropic refractive index of about 400 nm to about 480 nm.

14. The liquid crystal display of claim 1, wherein the liquid crystal layer has a dielectric anisotropy of about 7 to about 13.

15. A method of manufacturing a liquid crystal display, comprising:
forming a liquid crystal layer between a first substrate and a second substrate;
forming a retardation layer on the second substrate;
positioning a first polarizing plate on an outer surface of the first substrate so that the first substrate is positioned between the retardation layer and the first polarizing plate; and
positioning a second polarizing plate on the retardation layer so that the retardation layer is positioned between the second substrate and the second polarizing plate, wherein the retardation layer has refractive indices that satisfy n_{z}<nₓ=n_{y}, where nₓ, n_{y}, and n_{z} denote refractive indices in x-, y-, and z-axis directions when one surface of the second substrate is an x-y plane surface defining the x- and y-axis directions and substantially parallel to a surface of the liquid crystal display that is configured to display an image, and the z-axis direction is perpendicular to the x- and y-axis directions.

16. The method of claim 15, wherein the forming a retardation layer further comprises:
mixing a discotic liquid crystal having the refractive indices that satisfy n_{z}<nₓ=n_{y} with a solvent, so as to form a discotic liquid crystal solution;
coating the solution on the second substrate to form an initial retardation layer; and
curing the initial retardation layer to form the retardation layer.

17. The method of claim 16, wherein the curing the initial retardation layer further comprises:
pre-baking the initial retardation layer; and
exposing the initial retardation layer.

18. The method of claim 15, wherein the first polarizing plate comprises:
a compensation film disposed on the first substrate; and
a first polarizing film disposed on the compensation film and having a first polarization axis, wherein the compensation film is formed by biaxial-stretching.

19. The liquid crystal display of claim 3, wherein the compensation film is not a DLC compensation film.
